(19) United States
(12) Patent Application Publication
(10) Pub. No.: US 2008/0236000 A1
(43) Pub. Date: Oct. 2, 2008

(54) Craft Set and Elements for Constructing Pop-Up Cards

(76) Inventor: Charles Robert Bostick, San Pedro, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/135,782

(22) Filed: Jun. 9, 2008

Related U.S. Application Data
(62) Division of application No. 11/021,136, filed on Dec. 21, 2004, now abandoned.
(60) Provisional application No. 60/532,198, filed on Dec. 23, 2003.

(51) Int. Cl. G09F 1/00

(52) U.S. Cl. 40/124.08; 40/124.11; 40/124.14; 40/124.09

(57) ABSTRACT

A craft kit for making pop-up cards having a plurality of pop-up construction elements of different configurations, each configuration of construction element being provided in plurality, each configuration comprising a sheet-like member with predefined fold lines and selective areas coated with adhesive for joining to a card and to a pop-up element to create motion in the pop-up element when a card is opened. Such a kit may contain multiple ones of multiple construction elements, with or without blank cards, or may simply include multiple construction elements, all of the same design, typically for use as replacements for those used from a larger kit, or of a special or new design not normally included in original kits. Various construction elements and their uses are disclosed.

### CROSS-REFERENCE TO RELATED APPLICATION

This application claims the benefit of U.S. Provisional Patent Application No. 60/532,198 filed Dec. 23, 2003.

### BACKGROUND OF THE INVENTION

1. Field of the Invention

The present invention relates to the field of pop-up or animated cards.

2. Prior Art

Some greeting cards have features that create motion or animation when opened. Such cards are generally referred to herein as pop-up cards, and can range from simple, single element motion to very complex scenes that open into the third dimension when the card is opened. However at the present time, such cards are quite expensive and are not personalized in any way.

There is a substantial market for craft items, and in that regard, some people make their own cards to give them a personalized touch. With the advent of personal computers, electronic cameras and color printers, color pictures can be taken, scaled and printed as needed for card construction. However there currently are no pop-up card construction elements or sets of elements on the market that enable one to conveniently create a pop-up card personalized in this way. Consequently such cards are usually simple cards with no animation of any kind. While one could fabricate personalized pop-up cards from scratch, so to speak, such a card would be time consuming and require substantial ingenuity to make. However a good craft set of pop-up card construction elements could go a long way in providing much of the ingenuity needed and reduce the time required for such card construction, thereby creating an interesting and creative activity for both adults and children.

### BRIEF DESCRIPTION OF THE DRAWINGS

FIGS. 1a through 1n illustrate basic building blocks and their use in accordance with the present invention.

FIGS. 2a through 2h illustrate other forms of pop-up construction members and their use.

FIGS. 3a through 3d illustrate pivot construction members I accordance with the present invention.

FIGS. 4a through 4g illustrate pull arms and slide guides in accordance with the present invention.

FIGS. 5a through 5j illustrate alternate construction elements and their use, the construction elements being similar to those of FIGS. 2a through 2h.

FIGS. 6a through 6c illustrate hinge construction elements.

FIGS. 7a through 7f illustrate another pop-up element and its use.

FIGS. 8a and 8b illustrate a stay open latch and its use.

FIGS. 9a through 9c illustrate a standup base construction element and its use.

FIGS. 10a through 10d illustrate a linkage system and its operation.

FIGS. 11a through 11i illustrate various additional forms of construction elements.

FIGS. 12a through 12d illustrate a twist latch construction element and its use.

FIGS. 13a and 13b illustrate a three-dimensional pop-up that may be constructed using the construction elements of the present invention.

FIGS. 14a and 14b illustrate another three-dimensional pop-up that may be constructed using the construction elements of the present invention.

FIG. 15 is a schematic representation of a pop-up card craft kit containing multiple construction elements of various kinds in accordance with the present invention.

### DETAILED DESCRIPTION OF THE PREFERRED EMBODIMENTS

The present invention comprises craft sets and construction elements for pop-up card construction that will allow the user to make endless varieties of pop-up cards, such as personalized pop-up cards. The construction elements do not provide the pop-ups themselves, but rather provide the structural members and mechanisms typically needed or useful to achieve the desired pop-up function for pictures, artwork or other subject matter provided by the user. In that regard, as used herein, the word “pop-up” is used in the general sense to indicate motion, animation or three dimensions in a card when the same is opened. The construction elements may be sold, by way of example, as a craft set containing a plurality of different kinds of construction elements, or as a plurality of each individual type of construction elements.

The structural members and mechanisms of the present invention preferably contain no graphics or artwork themselves, and more preferably are fabricated of clear plastic semi-rigid sheet so as to not detract from the artwork, photographs or the like that the user will display by way of the pop-up structure or mechanism. Also preferably, the pop-up structural members and mechanisms are coated with a self-sticking adhesive in appropriate locations and are provided in plurality on an easy release backing. The various pop-up structural members and mechanisms may take many forms, some of which are disclosed herein by way of example.

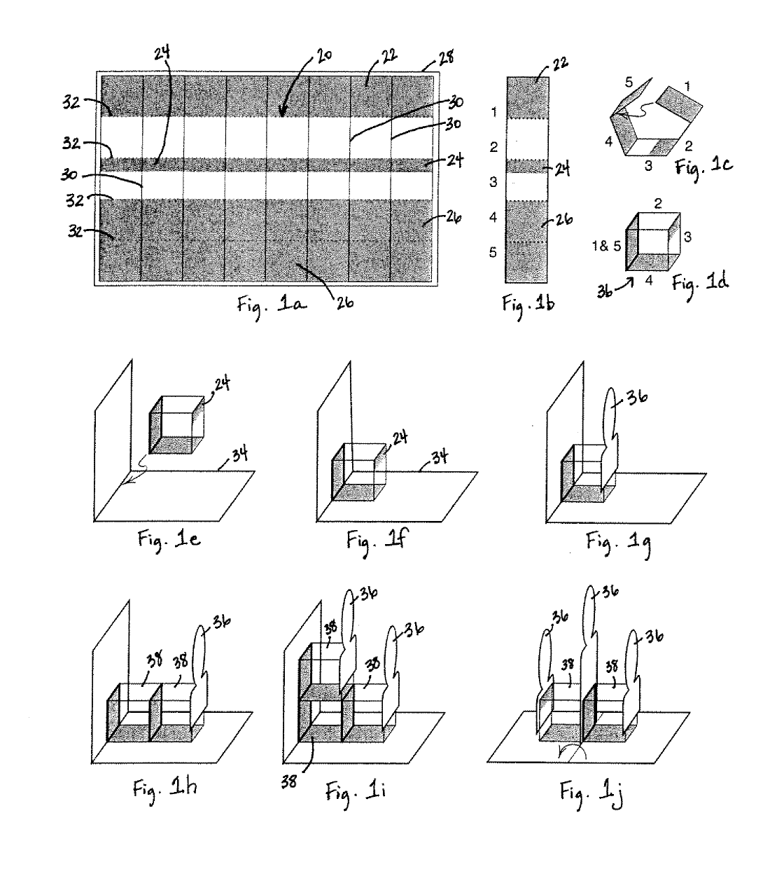

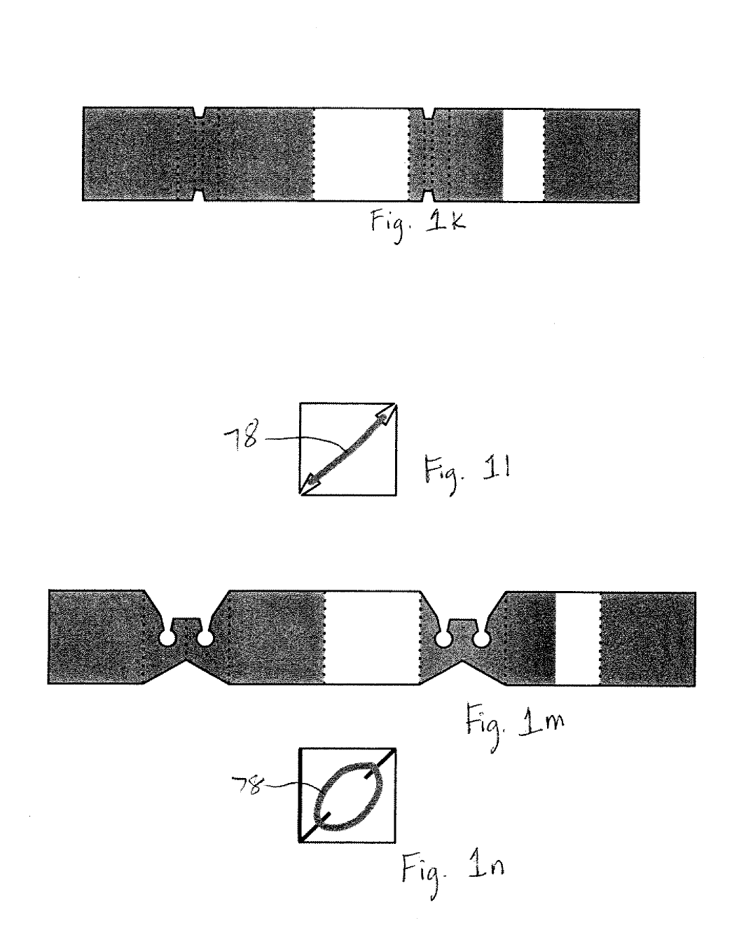

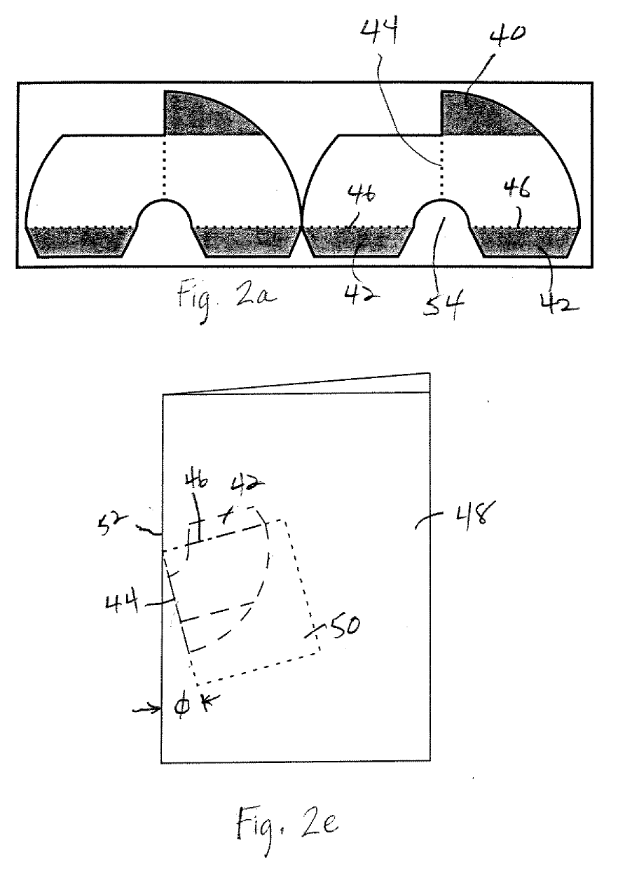

First referring to FIG. 1a, one form of pop-up card structural member or building block in accordance with the present invention may be seen. As shown therein, a sheet of clear plastic, generally indicated by the numeral 20, is coated with a self-sticking adhesive in three strips, namely, strips 22, 24, and 26, which are protected by an easily peelable backing 28. The sheet of clear plastic is separated into strips by cuts 30 so as to be individually separable from the backing as shown in FIG. 1b. Also, four substantially equally spaced fold lines 32 are defined across the clear plastic sheet by any convenient means, such as by perforations, scoring or otherwise defining lines of reduced resistance to bending. In that regard, materials such as polyethylene or polypropylene, commonly used for living hinges, may be used for the plastic sheet, and if desired a living hinge-type structure may be used for the lines of reduced resistance to bending, as these lines are used as hinges in the final pop-up card.

The lines of reduced resistance to bending define five regions 1 through 5 as shown in FIGS. 1b and FIG. 1c. In that regard, in FIG. 1c, an individual plastic member such as shown in FIG. 1b is bent along the hinge lines with the adhesive facing outward and with layers 5 and 1 being joined together to form a simple square structure as in FIG. 1d. Since panels 1 and 5 (FIG. 1b) are both coated with adhesive, either panel may overlay the other to bond the strip into the square (or rectangular) structure shown while still leaving a self-stick adhesive coated exterior face on the respective surface of the square structure.

When assembled, the square structure, as shown in FIGS. 1d through 1f, has a back and bottom self-sticking adhesive coated exterior surface for adhering to a card, such as card 34 shown in FIG. 1f. It also has an adhesive coated area 24 to which a pop-up 36, such as shown in FIG. 1g, may be adhered. The region 24 may be in any shape and may, if desired, cover the entire surface of the pop-up, though it is preferable not to have the entire surface coated with self-sticking adhesive, as part of that adhesive may be exposed and stick to the card surface when the card is folded closed. The strip 24 is a convenient configuration, as it allows the clear plastic sheet 20 (FIG. 1a) to simply be coated with self-sticking adhesive in strips across the clear plastic, though other adhesive placement may be used if desired.

When the card of FIG. 1g is folded closed, pop-up 36 of course will lie flat in the card between the front and back covers thereof, though it will pull up to the position shown when the card is opened. If desired, two of the members 36 may be used back to back as shown in FIG. 1h to provide additional depth for the pop-up, with still one or more additional members being used as shown in FIGS. 1i and 1j to provide varying degrees of depth or third dimension for the pop-ups. Alternatively, the dimensions and hinge locations shown in FIG. 1a may be varied to provide hinge assemblies 36 of more than one size if desired, for still further three-dimensional effects in the pop-up card.

The square or rectangular structures just described operate when the card is opened. As an alternative, embodiments shown in FIGS. 1k through in use a rubber band 78 to provide a self-opening feature, the structures being pulled to the open position automatically.

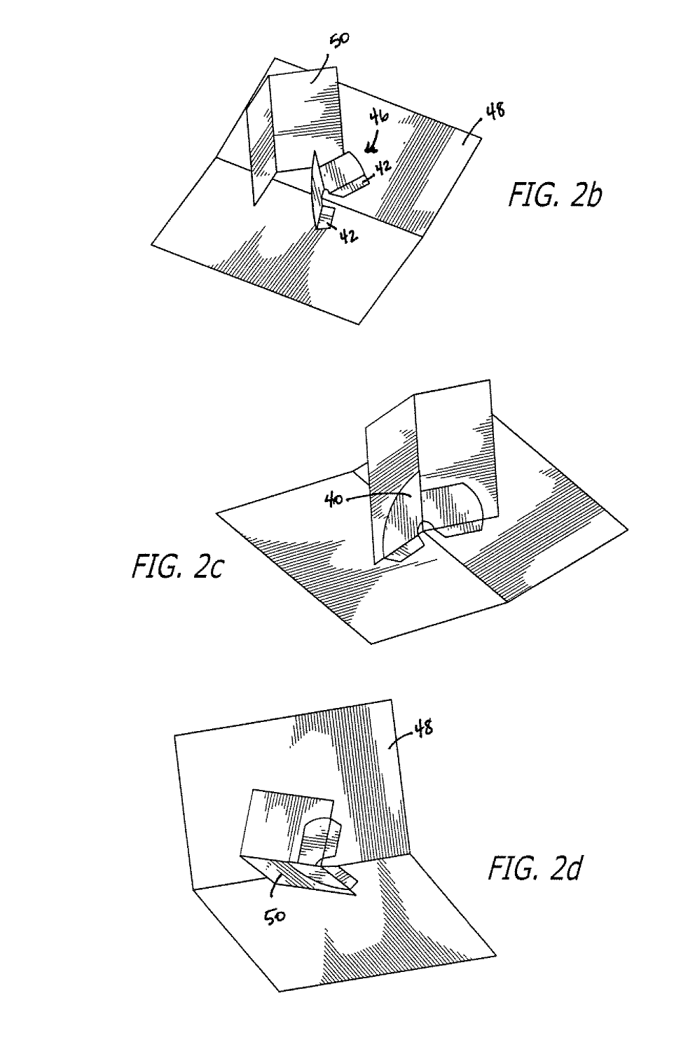

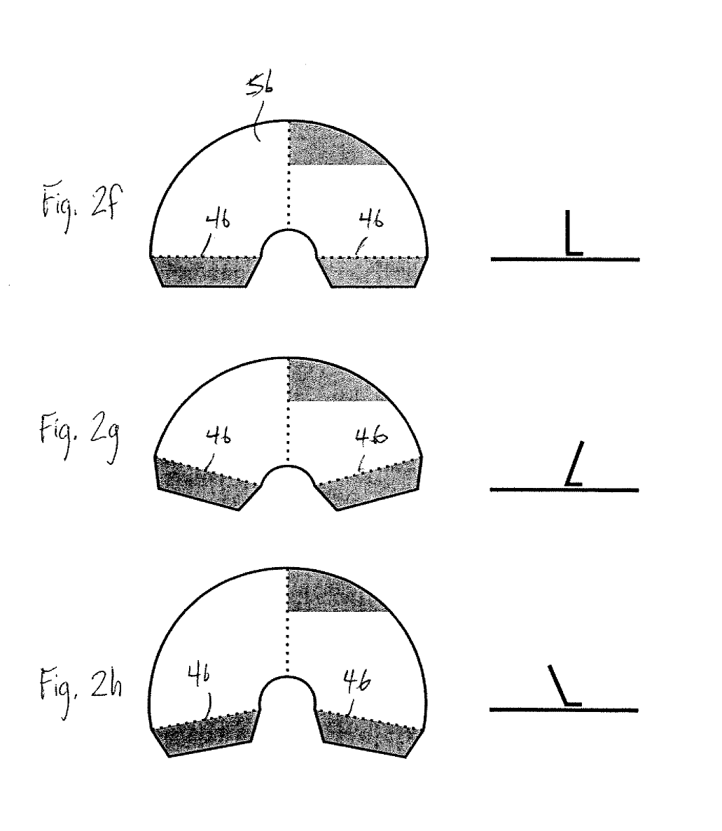

Now referring to FIG. 2a, a further pop-up card construction element may be seen. This element will be referred to herein as the V-fold stand-up element, intended to support and provide a pop-up element in the V-fold of a card as the card is opened. This particular embodiment is characterized by adhesive coated areas 40 and 42 and lines of reduced resistance to bending 44 and 46. FIGS. 2b through 2e illustrate the use of the V-fold element. In particular, as shown in FIG. 2b, the V-fold element, generally indicated by the numeral 47, has adhesive coated regions 42 adhered to each side of the V-fold of the card 48. The pop-up member 50 is adhered to adhesive coated region 40. When the card is opened and lying flat as shown in FIG. 2b, in this embodiment the V-fold member 46 will stand perpendicular to the surface of the card. When the card 48 is folded toward the closed position as shown in FIG. 2d, the V-fold member, as well as the pop-up 50, will fold in the middle as shown, to lie flat as shown in FIG. 2e when the card 48 is closed. As may be seen in that Figure, preferably the intersection of fold line 44 and fold lines 46 on the V-fold member is as close to the fold line 52 of the card 48 as reasonably possible. Also note the angle φ between fold line 44 on the V-fold member and fold line 52 on the card. This angle determines the angle the pop-up will assume about its central fold line (FIG. 2c) when the card is fully opened, though some angle is required for the pop-up to function. Also in this embodiment, it will be noted that the center lower corner 54 (FIG. 2a) of the V-fold member is cut away. This provides some flexibility between adhesive coated regions 42 to prevent binding on opening of the card, particularly if the junction between fold lines 44 and 46 is not positioned right on the fold line 52 of the card, and helps accommodate the build-up of the material thicknesses.

In the embodiment of the V-fold shown in FIG. 2a, adhesive coated region 40 is positioned at one side of the fold line 44, with the V-fold member being cut away on the opposite side of the fold line. This allows the adhesive areas to be coated in strips while still having the adhesive coated area which will support the pop-up itself appearing only on one side of the fold line 44. This is desired to prevent binding of the pop-up by allowing the part of the pop-up on the other side of the fold line to slide on the surface of the V-fold pop-up member. Thus, as may be seen in FIG. 2d (viewed from the back of the pop-up member), the adhesive coated region 40 pulls the pop-up upward while the V-fold member itself forces the pop-up to unfold about its central fold line. Thus the adhesive coated areas on both sides of the fold line of the pop-up member are not required and can be a disadvantage rather than an advantage.

Now referring to FIGS. 2f, 2g and 2h, alternate V-fold members may be seen. The V-fold member of FIG. 2f is similar to that of FIG. 2a, though rather than having region 56 cut away, it is simply not coated with adhesive. Like FIG. 2a, fold lines 46 are coaxial so that each panel of the pop-up will stand perpendicular to the face of the card when the opened a full 180°. In FIG. 2g the fold lines 46 are angled in a first direction which causes the pop-up to swing upward more than 90°when the card is opened the full 180°. The fold lines 46 in FIG. 2h are angled in the opposite direction, which in turn, will cause the pop-up to swing upward less than 900 when the card is fully opened.

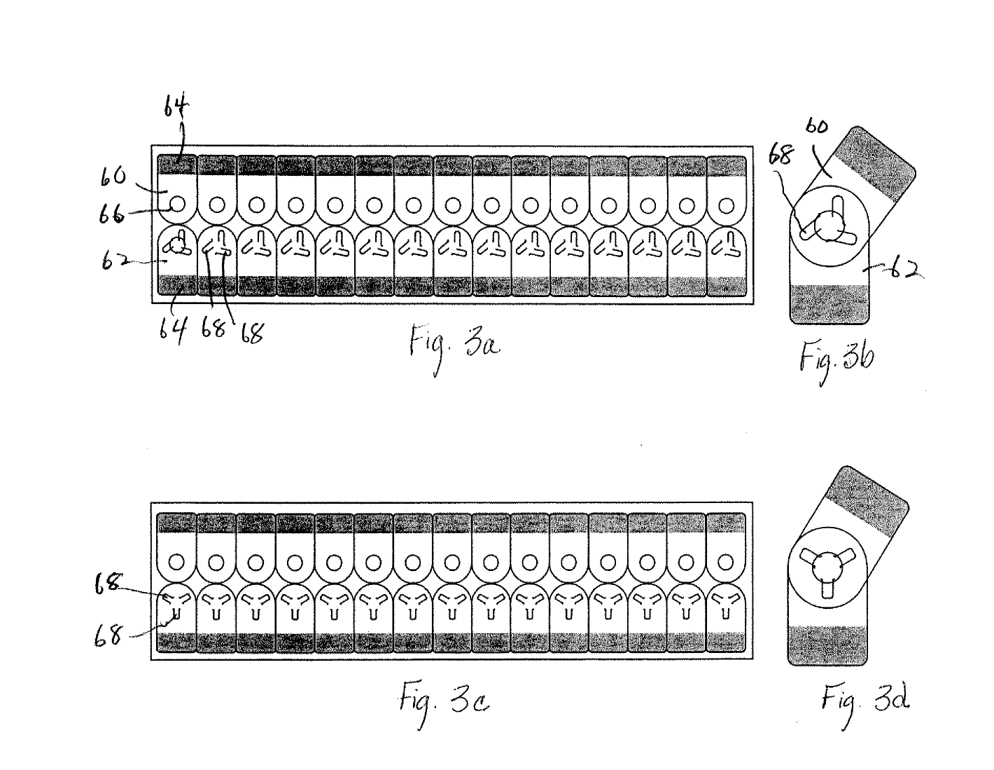

Now referring to FIGS. 3a and 3b, a pop-up card construction element in the form of a rotational element may be seen. The rotational element is comprised of two members 60 and 62, each having an adhesive coated area 64, again in this embodiment in the form of strips for ease of manufacture. Members 60 have holes 66 therein, with member 62 being cut to have flexible outward extending fingers 68. Fingers 68 may be flexed to pass through holes 66 in member 60 as shown in FIG. 3b to provide a rotational element which may be used singularly or coupled to each other or other construction elements for some form of motion or animation in a card when it is opened. FIGS. 3c and 3d are similar to FIGS. 3a and 3b, though the fingers 68 are oriented in a radial fashion rather than in the manner illustrated in FIGS. 3a and 3b. Obviously other forms may also be used, or other numbers of fingers may be used to achieve the results, these embodiments merely being examples of one basic construction of rotational elements.

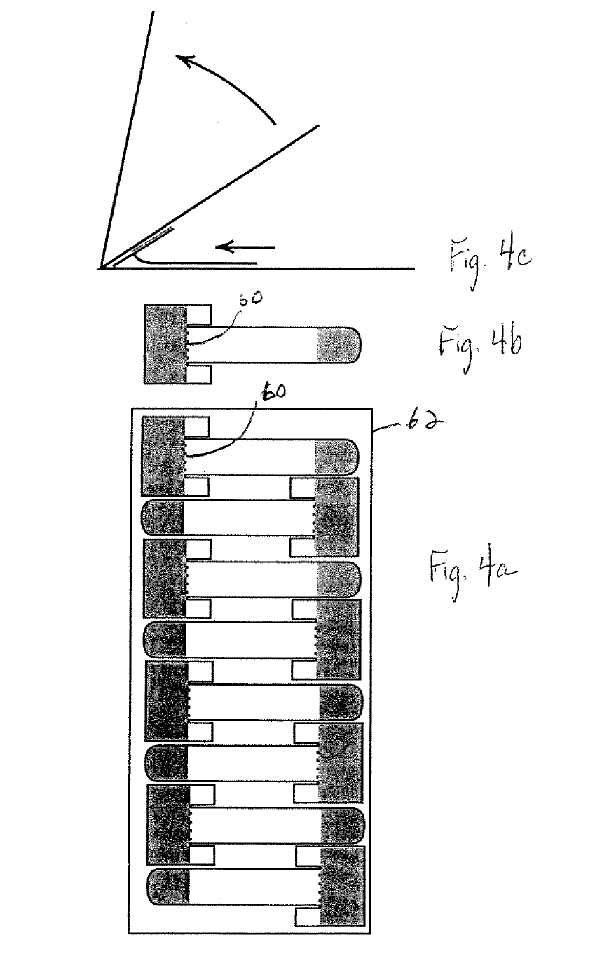

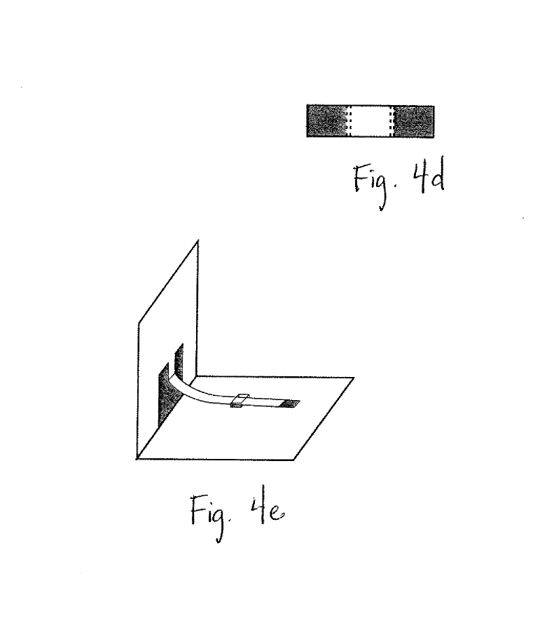

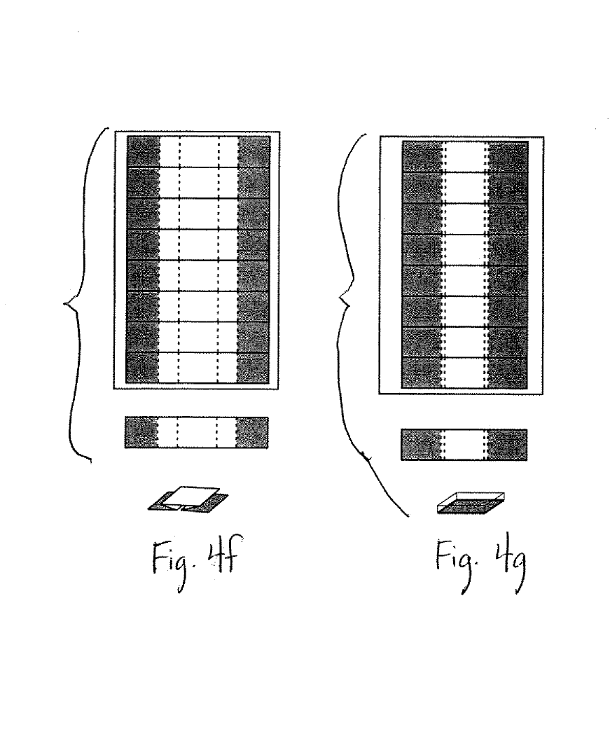

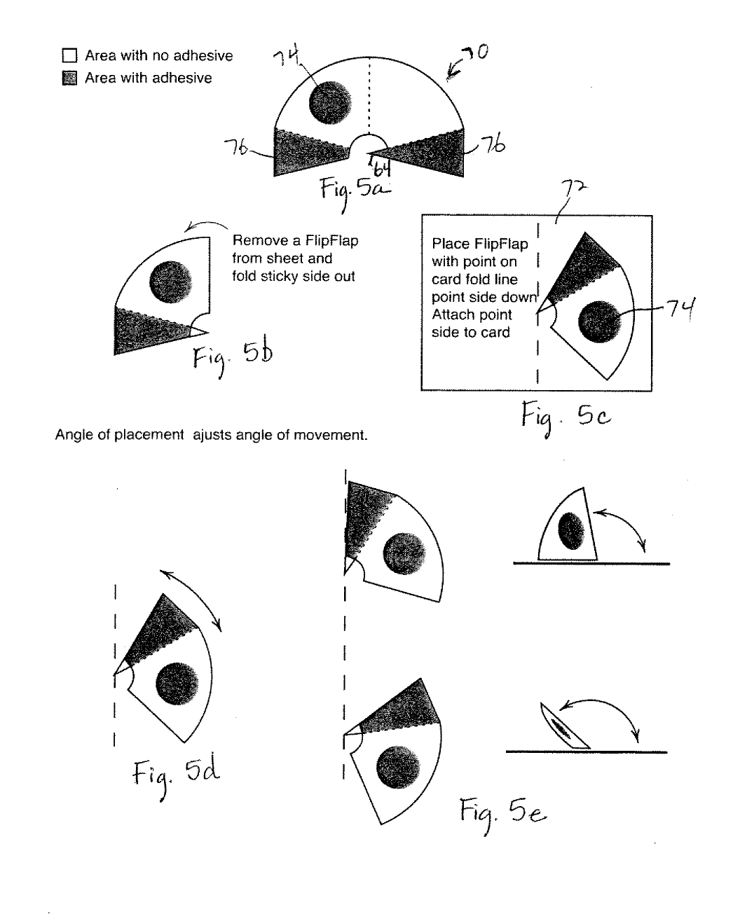

Now referring to FIGS. 4a, 4b and 4c, a still further pop-up card construction element may be seen. This element is also self-sticking adhesive coated in two strips with a hinge line 60 thereon. Like the other construction elements, the adhesive strips are protected by an easy peel backing 62 and can be adhered to a card as shown in FIG. 4c to provide lateral motion to a card element as illustrated in FIG. 4c. Elements like this may be used to impart relative lateral motion to moveable elements on the card, such as to open eyes, move an arm, etc.

The element of FIGS. 4a through 4c may be used with a slide guide element, such as illustrated in FIGS. 4d and 4e. The slide guide element may be of various configurations and folded in various ways, as illustrated in FIGS. 4f and 4g.

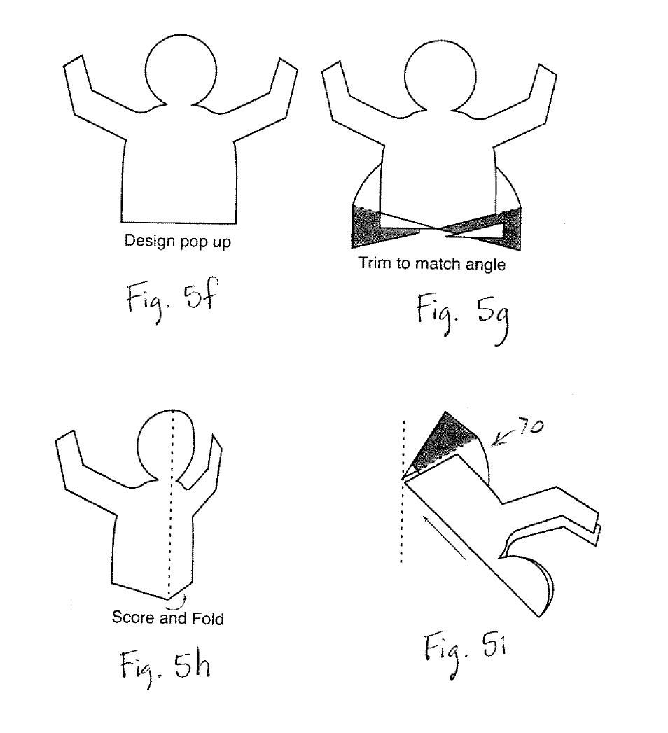

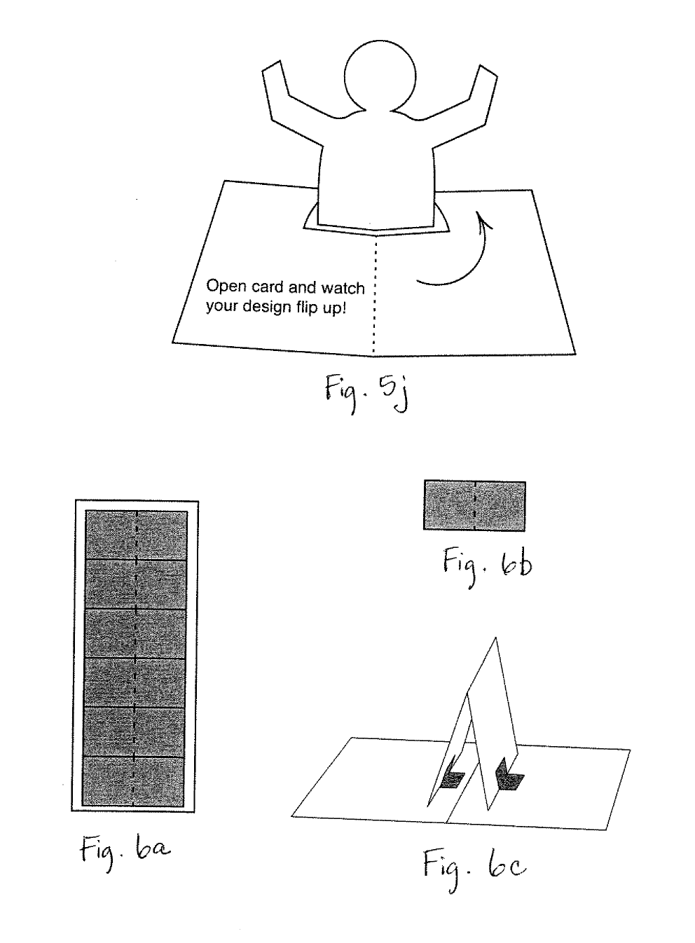

An alternate form of pop-up element similar to that illustrated in FIGS. 2a through 2h may be seen in FIG. 5a. In particular, as may be seen in FIG. 2e, the fold lines need to intersect at the fold line of the card to work ideally. Thus the embodiment of FIG. 5a has a point 64 to assist in obtaining the proper location. In use, the element 70 of FIG. 5a, normally formed by die cutting on a backing sheet, is first removed from the sheet and folded about the center fold line, sticky side out, as shown in FIG. 5b. Then the element 70 is placed in the unfolded card 72 with the point on the fold line, as shown in FIG. 5c.

The angle at which element 70 is placed on the card is up to the user, as shown in FIG. 5d, the angle affecting the position of the pop-up when the card is opened as illustrated in FIG. 5e. The pop-up itself, which for purposes of illustration may be a cutout picture of an individual schematically shown in FIG. 5f, is trimmed at the bottom thereof to match the angle of the side fold lines on element 70, as illustrated in FIG. 5g. Then the pop-up is folded about its centerline, or scored and folded as shown in FIG. 5h, and then placed in position with the fold line of the pop-up against the fold line of element 70. Now, by closing the card, adhesive coated regions 76 (FIG. 5a) will both be adhering to the card, one on each side of the fold line, so that when the card is opened as shown in FIG. 5j, the pop-up will rise and unfold as illustrated.

It will be noted that in the preferred embodiment, as before, only one adhesive coated area 74 is provided, rather than two such areas, one on each side of the center fold line. While two such areas could be used, a single area is preferred as the pop-up will automatically fold when the card is closed, and better folding and unfolding is achieved if the pop-up is restrained only on one side of the fold line, not both sides.

Another construction element of a particularly simple configuration may be seen in FIGS. 6a, 6b and 6c. That element is a simple hinge, characterized by two areas both adhesive coated, separated by a fold line, with FIG. 6c illustrating a simple example of the use thereof. Obviously, either hinge may be on either side of the pop-up as desired.

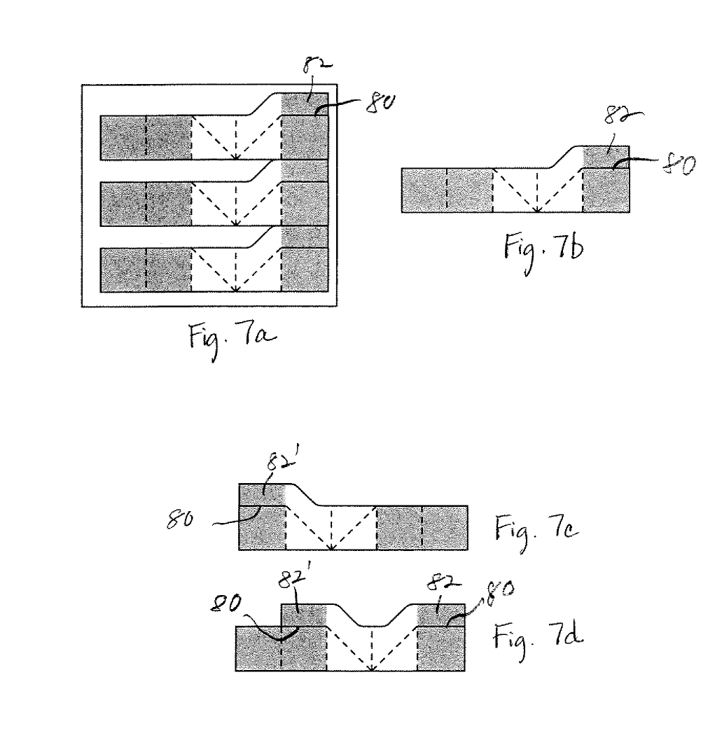

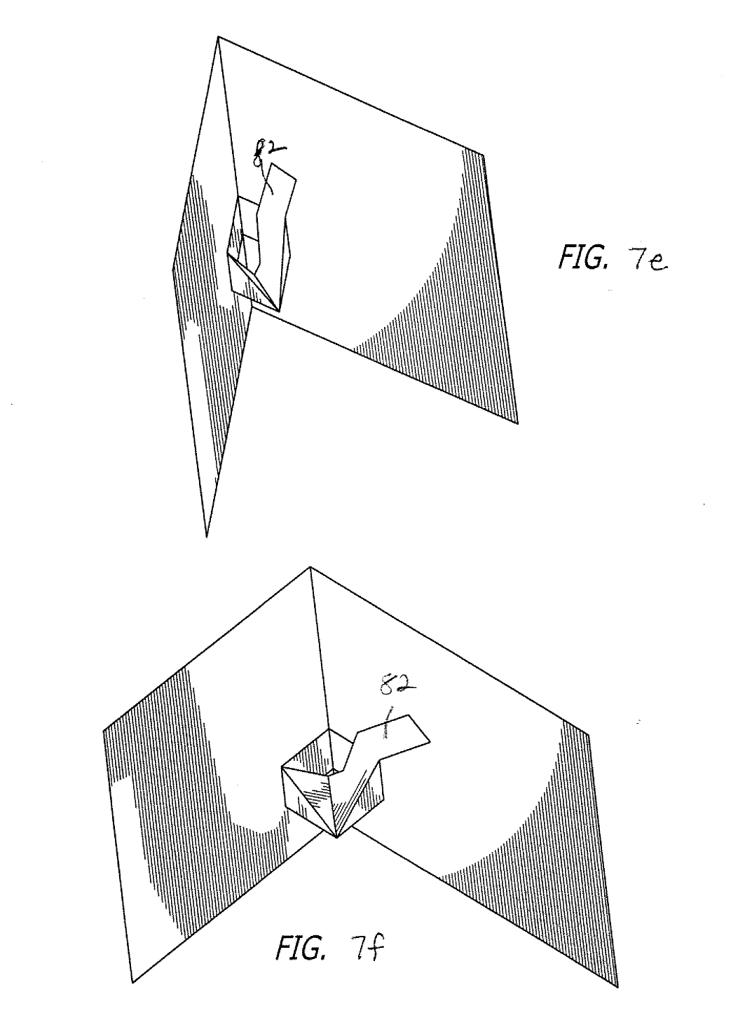

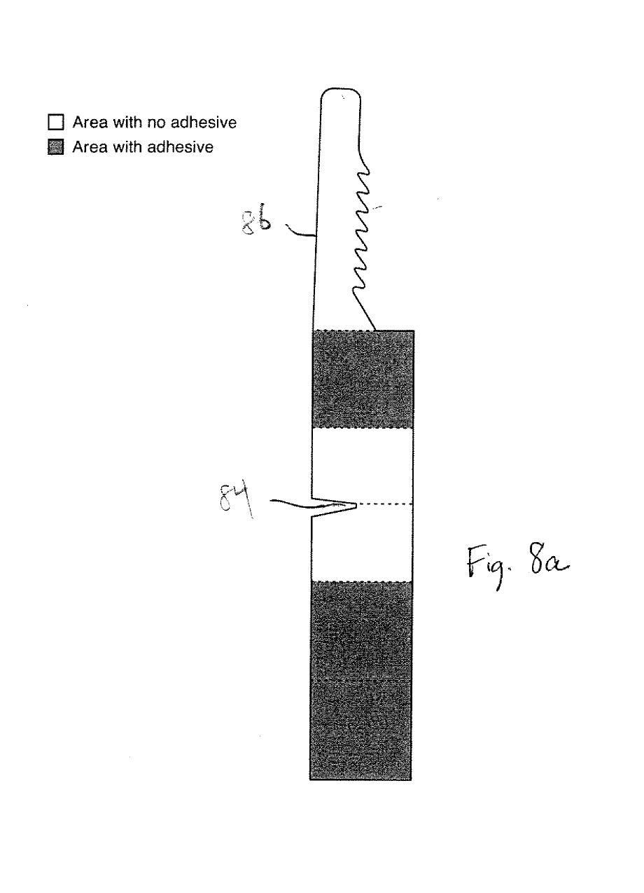

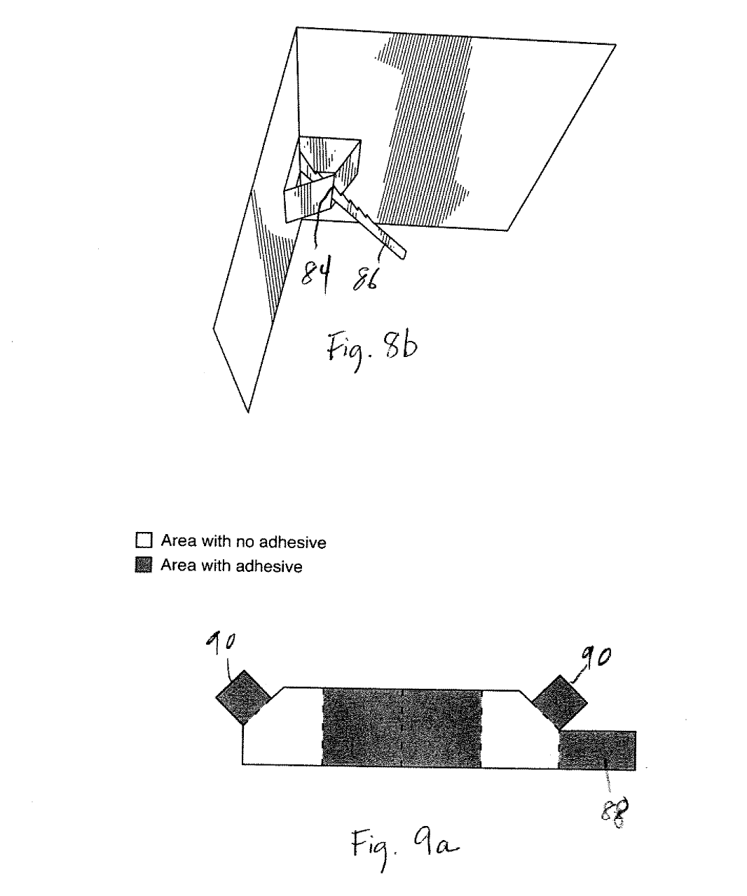

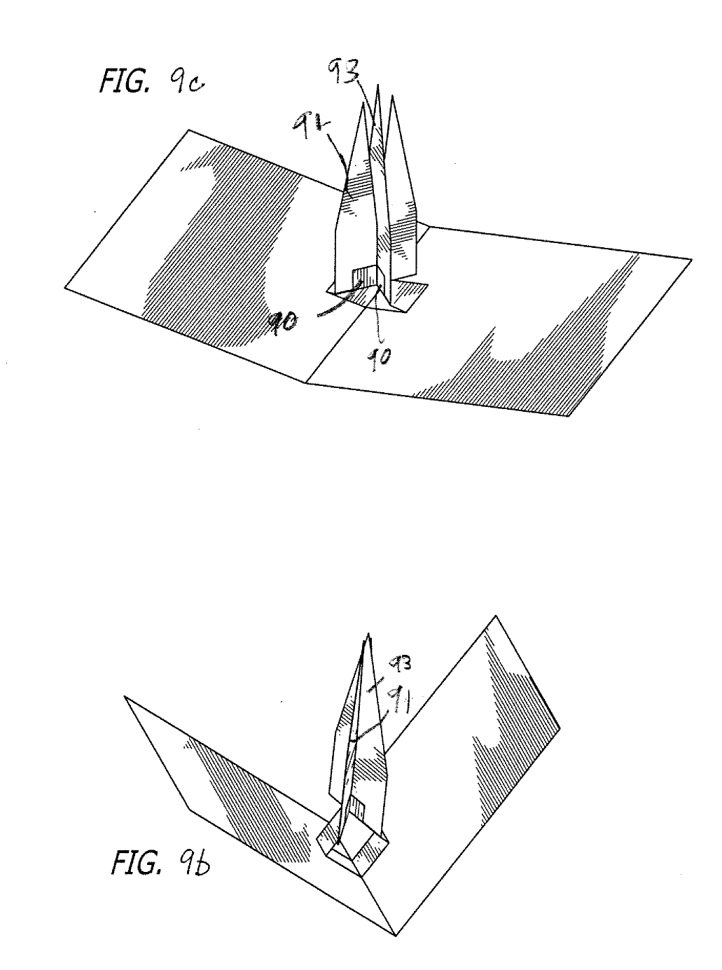

Now referring to FIGS. 7a through 7d, embodiments of a construction element to create an arm waving type of motion may be seen. FIG. 7a shows a plurality of such elements on the backing sheet, with FIG. 7b showing an individual element, the solid lines 80 are slit lines, whereas the dashed lines as before are lines of reduced resistance to bending, or fold lines. Like the embodiment of FIG. 1, there are five basic panels to this element, allowing the element to be folded and self-secured into a square shape, though with additional fold lines in two of the panels. These panels are folded inward as shown in FIGS. 7e and 7f, with the folds moving the arm 82 upward when the card is closed (FIG. 7e) and downward as the card is opened (FIG. 8f). FIGS. 7c and 7d show variations, FIG. 7c showing an arm 82′ which will move up and down against the left panel of the card, and FIG. 7d showing two arms 82 and 82′ which will move on each side of the card as the card is opened. The arms, of course, have adhesive thereon to support whatever decoration is desired.

Another variation of the embodiment shown in FIG. 1 is illustrated in FIGS. 8a and 8b. This embodiment, like the embodiment of FIG. 1a, has five panels with adhesive coating on both end panels to be able to fold the same into a square shape. Protrusion 86 extends from one end of the panels, however, which when folded slightly along the fold line may protrude through the slot 84 between panels. In essence, the sawtooth edge on the protrusion 86 engages the bottom of the slot 84 to allow the opening of the card as shown in FIG. 8b, but to resist closing, thereby keeping the card open.

FIGS. 9a, 9b and 9c illustrate a still further variation. Here the fifth panel 88 is shorter than the other panels, though being adhesive coated, when all panels are folded about their fold lines, panel 88 may adhere to the backside of the panel on the other end to hold the same in a flexible square shape. In use, the two main adhesive coated panels are adhered to each side of the fold line of a card, and tabs 90 may be each fastened to a respective one of inter-fitting pop-up members 91 and 93 as shown. When the card is closed, the two pop-up members fold together within the card, and when the card is opened, the pop-up members unfold, generally bisecting the angle between the two card panels as it is opened.

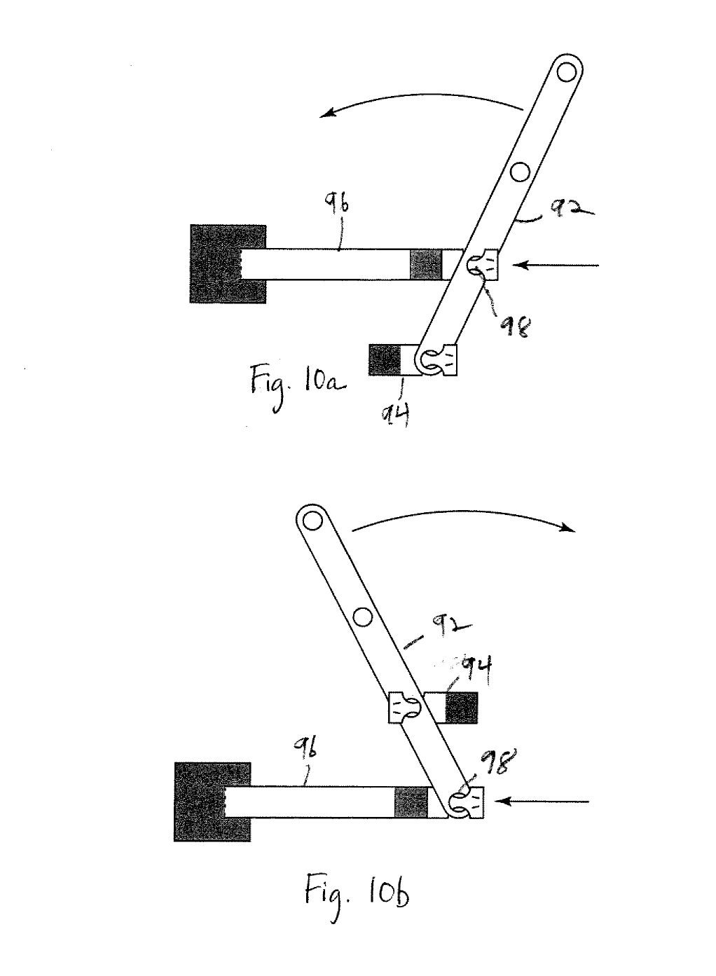

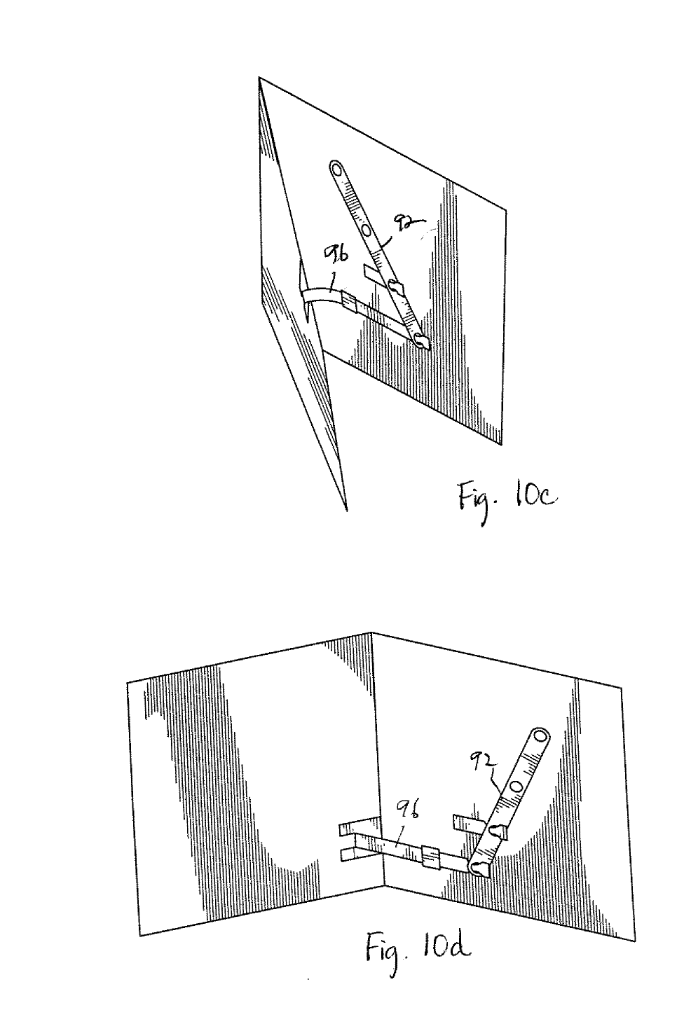

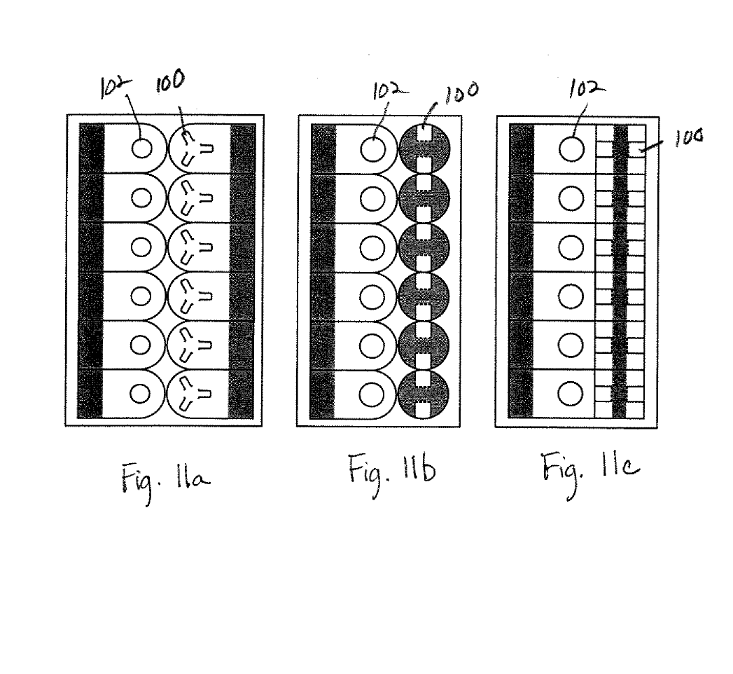

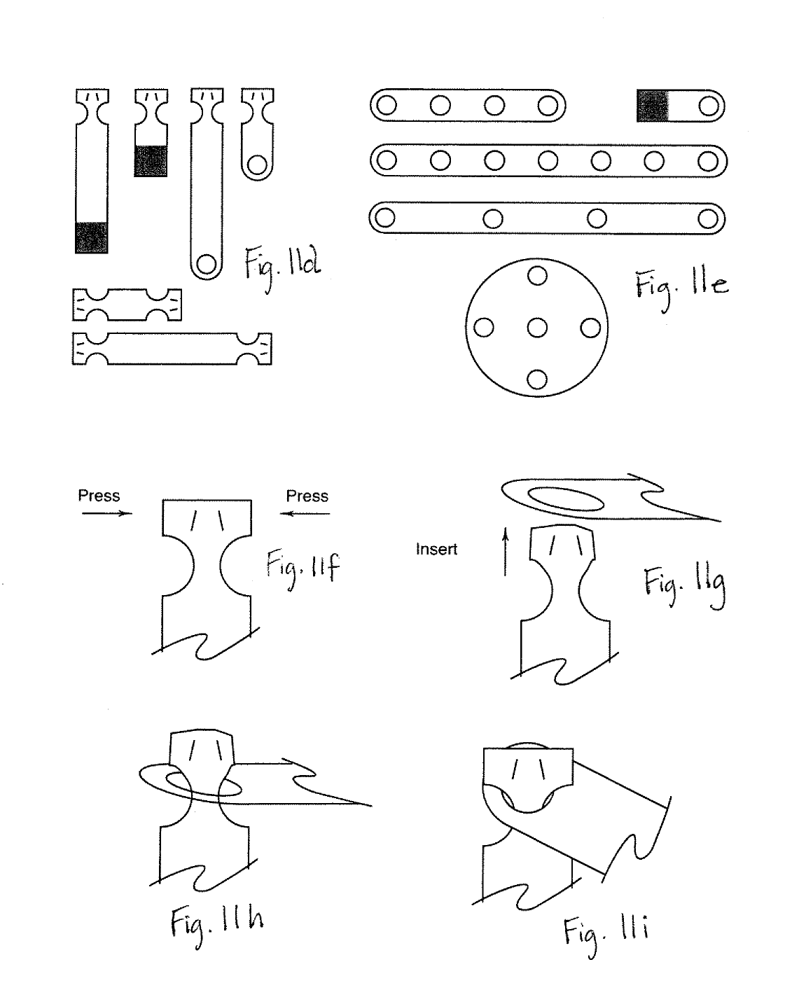

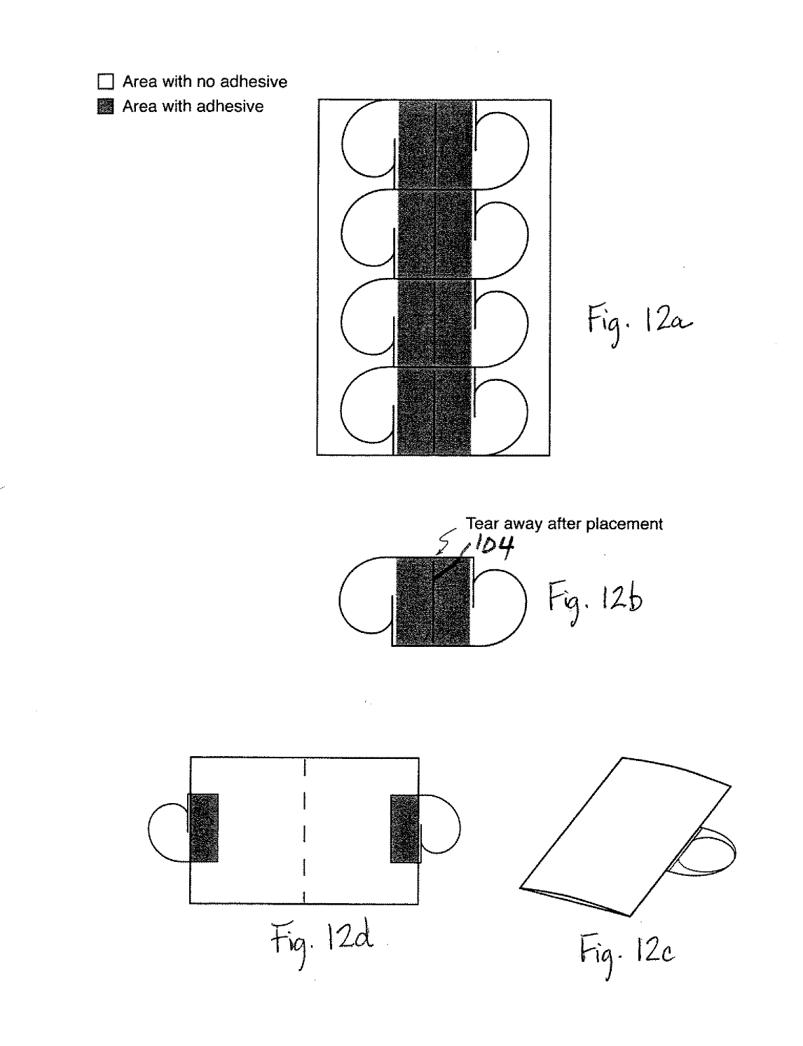

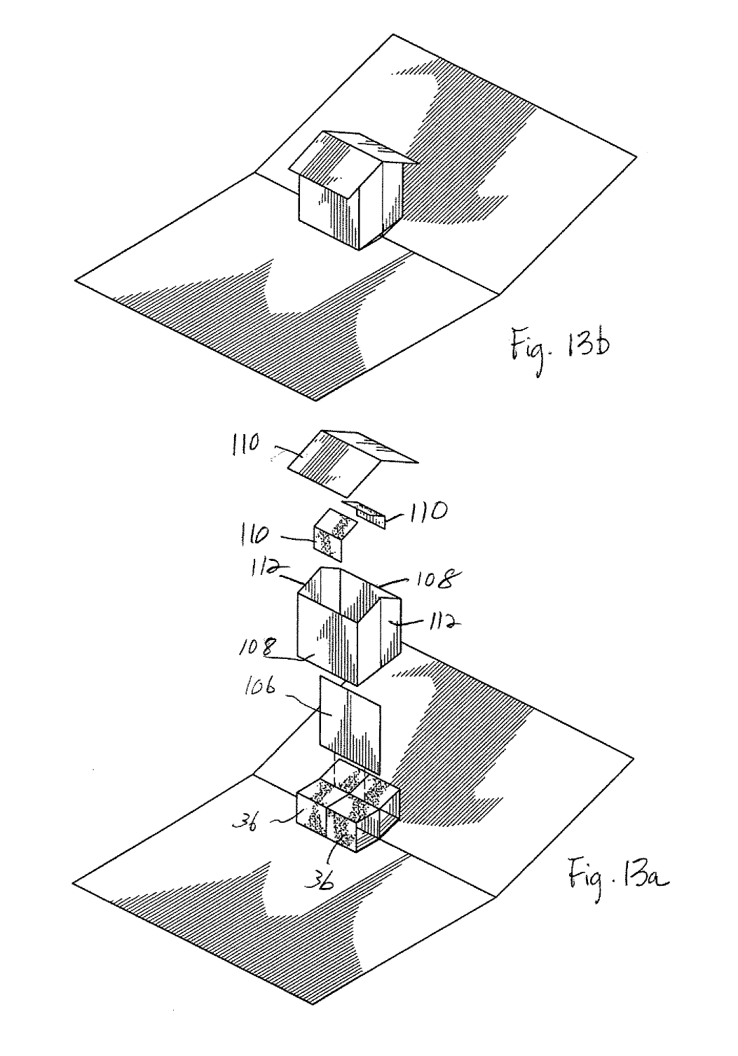

Now referring to FIGS. 10a and 10b, other construction elements in accordance with the present invention may be seen. Here an arm 92 is fixed to a pivot point by element 94 on one side of a card, with a pull arm 96 attached to the opposite side of the card, being coupled thereto through another pivot point 98 to swing the arm when the card is opened. Motion in either direction may be obtained, dependent upon the arrangement of the various parts as illustrated in FIGS. 10a and 10b. In that regard, an arrangement similar to that of FIG. 10b is illustrated in operation in FIGS. 10c and 10d. Of course typically, a pop-up or part of a pop-up would be attached to the arm, in some cases together with a more complicated linkage as desired. In that regard, rotational joints of exemplary configurations may be seen in FIGS. 11a through 11c. In each case, tabs 100 are temporarily deflectable so as to pass through opening 102 in the cooperative member to provide a pivot point for a pop-up, usually rotatable by one of the linkages hereinbefore described. Alternate forms of linkages and pivots are illustrated in FIGS. 11d and 11e, with FIGS. 11f through 11i illustrating the temporary deflection of the end of one member to pass through the opening in another linkage member.

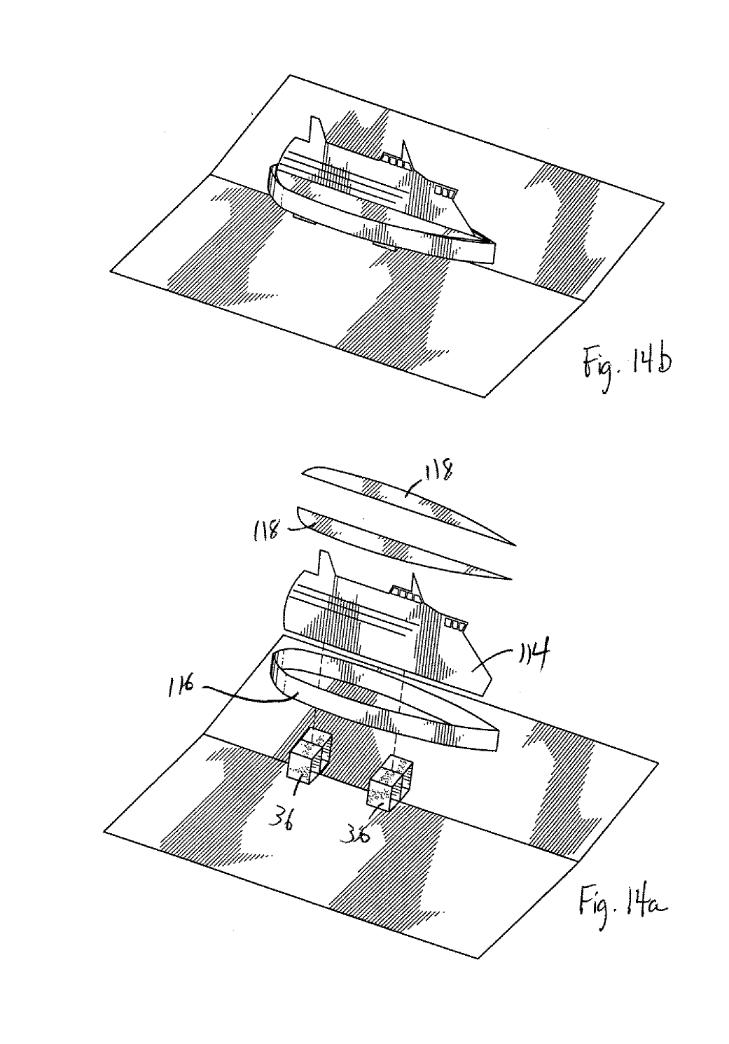

In FIGS. 12a and 12b, a twist latch member is illustrated. That member may be folded along slit 104 and attached to each side of a card, as illustrated in FIG. 12c. Then the two parts may be separated by either tearing, or possibly using a knife or razor blade, to separate the two parts now forming the desired twist latch for the card. While FIG. 12c shows the adhesive portions bonding to the inside of each side of the card, they may equally as well be bonded to the outside of the card, though that would require either separation of the two parts and separate placement of the same on the card, or opening the card so the card panels are temporarily substantially back to back and fastening the latch in place as first described.

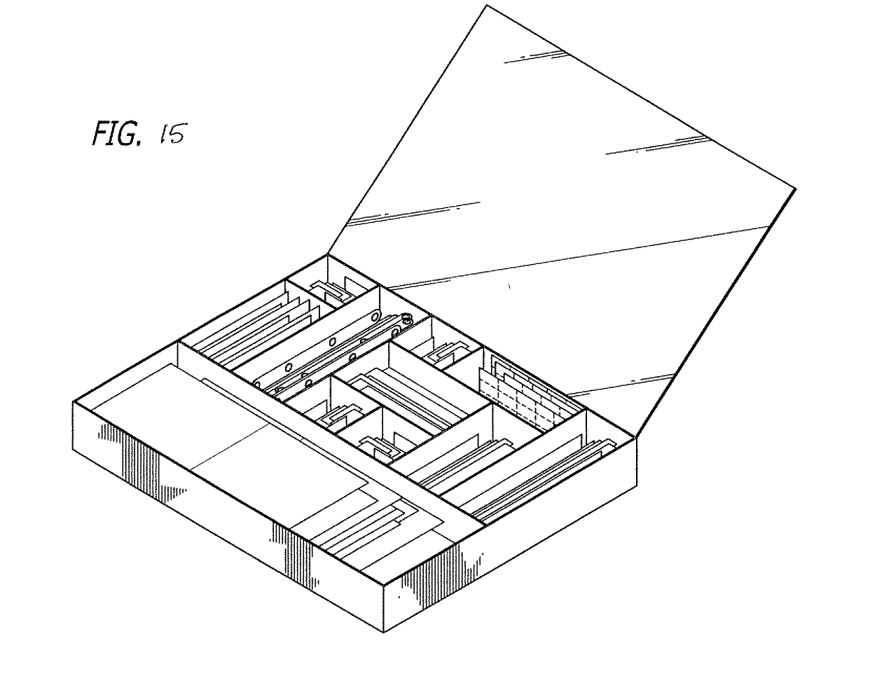

Having now described various exemplary construction elements and some of the functions provided thereby, two examples of unusual type of pop-up elements that may be constructed with the simplest of construction elements will now be shown. In particular, in FIG. 13a the construction of a pop-up building is illustrated. As shown in FIG. 13a, the building is constructed using the basic building block 36 of FIG. 1d. The building blocks are placed, as shown in FIG. 13a, with panel 106 between the building blocks. With this construction, the outer surfaces of building blocks 36 also have adhesive thereon to attach the sides 108 of the building. The roof 110 is attached by hinge members 110 of FIGS. 6a through 6c. When the card is opened as shown in FIG. 13b, the three-dimensional building appears, though when the card is folded toward the closed position, the ends 112 of the building fold outward, the building blocks 36 and the sides 108 of the building fold inward, and the roof 110 folds upward, all to lie flat when the card is closed. Thus the building blocks of the present invention can not only be used to create motion in a two-dimensional pop-up, but may also be used to construct three-dimensional pop-ups.

Another example of a three-dimensional pop-up is shown in FIGS. 14a and 14b. This pop-up is in the form of a ship, using the basic building blocks 36 of FIG. 1d. Like the pop-up of FIGS. 13a and 13b, the basic building blocks 36 attach to respective panels of the card and to the center member 114. The sides of the ship 116 are fastened to the adhesive coated sides of the building blocks 36. In this embodiment, adhesive is added to the top of building blocks 36 also to hold the deck members 118 in place. When the card is opened, the ship will appear as shown in FIG. 14b, though as the card is closed, building blocks 36 will start to collapse, raising the outer edges of the deck members 118 to fold them about a center line of the ship, with the sides of the ship 116 following the collapse of building blocks 36 so that all members of the ship will lie flat when the card is fully closed.

Finally, having shown and described exemplary pop-up card construction elements, a craft kit of multiple construction elements may be seen in FIG. 15. Such a kit may contain multiple ones of multiple construction elements, with or without blank cards, or may simply include multiple construction elements, all of the same design, typically for use as replacements for those used from a larger kit, or of a special or new design not normally included in original kits.

The foregoing disclosed pop-up card construction elements are mere examples of the varied kinds of elements that may be provided, individually or in a pop-up card construction kit, to be used either individually or in combinations to construct pop-up cards of a wide variety. Also, as used herein, the phrase pop-up cards is used in a general sense to indicate motion or animation on unfolding of one panel with respect to another panel, as in greeting cards and the like, though also includes such things as books, such as, by way of example, a project book for containing many examples of pop-up projects of the owner. Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

1-9. (canceled)

10. A craft kit for making pop-up cards comprising:
a plurality of construction elements, each construction element comprising a sheet-like member cut to a predetermined shape and having predefined fold lines and selective areas coated with adhesive for joining to a card and to a pop-up to create motion in the pop-up when the card is opened, the adhesive coated areas being protected by a peal strip there over, wherein the construction elements comprise an elongate strip having a first edge and four separate fold lines along its length, thereby defining five panels ordered one, two, three, four and five, the first, second and fifth panels having adhesive thereon, the fourth panel having an adhesive coated projection from a first side thereof, the third and fourth panels having fold lines intersecting on the fold line between the third and fourth panels and emanating therefrom toward the first edge at equal and opposite angles.

11. The craft kit of claim 10 wherein the third and fourth panels having fold lines intersecting on the fold line between the third and fourth panels at a second edge of the elongate strip.

12. A craft kit for making pop-up cards comprising:
a plurality of construction elements, each construction element comprising a sheet-like member cut to a predetermined shape and having predefined fold lines and selective areas coated with adhesive for joining to a card and to a pop-up to create motion in the pop-up when the card is opened, the adhesive coated areas being protected by a peal strip there over, wherein the construction elements comprise an elongate strip having a first edge and four separate fold lines along its length, thereby defining five panels ordered one, two three, four and five, the first panel and the fourth and fifth panels having adhesive thereon, the first panel being narrower than other panels, the second and fifth panels having additional fold lines adjacent comers thereof angled at approximately 45 degrees with respect to the fold lines between panels, the additional fold lines separating the second and fifth panel from first and second adhesive coated tabs, respectively.

13. A craft kit for making pop-up cards comprising:
a plurality of construction elements of different configurations, each configuration of construction element being provided in plurality, each configuration comprising a sheet member with predefined fold lines and selective areas coated with adhesive for joining to opposite sides of a fold line on a card and to a pop-up to create motion in the pop-up when the card is opened.

14. The craft kit of claim 13 wherein the sheet members are clear plastic sheet members.

15. The craft kit of claim 13 wherein one of the configurations of construction elements comprise an elongate strip having four separate fold lines along its length, thereby defining five panels, one panel at one end of the elongate strip and three other panels adjacent to each other having adhesive thereon, the remaining panel not having adhesive thereon.

16. The craft kit of claim 15 wherein the five panels are all substantially the same size.

17-21. (canceled)

22. A craft kit for making pop-up cards comprising:
a plurality of construction elements of different configurations, each configuration of construction element being provided in plurality, each configuration comprising a sheet-like member with predefined fold lines and selective areas coated with adhesive for joining to a card and to a pop-up to create motion in the pop-up when the card is opened, wherein one of the configurations of construction elements comprise an elongate strip having a first edge and four separate fold lines along its length, thereby defining five panels ordered one, two three, four and five, the first, second and fifth panels having adhesive thereon, the fourth panel having an adhesive coated projection from a first side thereof thereon, the third and fourth panels having fold lines intersecting on the fold line between the third and fourth panels and emanating therefrom toward the first edge with equal and opposite angles.

23. The craft kit of claim 22 wherein the third and fourth panels having fold lines intersecting on the fold line between the third and fourth panels at a second edge of the elongate strip.

24. A craft kit for making pop-up cards comprising:
a plurality of construction elements of different configurations, each configuration of construction element being provided in plurality, each configuration comprising a sheet-like member with predefined fold lines and selective areas coated with adhesive for joining to a card and to a pop-up to create motion in the pop-up when the card is opened, wherein one of the configurations of construction elements comprise an elongate strip having a first edge and four separate fold lines along its length, thereby defining five panels ordered one, two three, four and five, the first panel and the fourth and fifth panels having adhesive thereon, the first panel being narrower than other panels, the second and fifth panels having additional fold lines adjacent comers thereof angled at approximately 45 degrees with respect to the fold lines between panels, the additional fold lines separating the second and fifth panel from first and second adhesive coated tabs, respectively.

25. A craft kit for making pop-up cards comprising:
a plurality of construction elements, each construction element comprising a sheet member cut to a predetermined shape and having predefined fold lines and selective areas coated with adhesive for joining, alone or in combination with one or more additional construction elements, to a card on opposite sides of a fold line on the card and to a pop-up to create motion in the pop-up powered by the movement of the construction elements when the card is opened, the adhesive coated areas being protected by a peal strip there over.

26. The craft kit of claim 25 wherein the sheet members are clear plastic sheet members.

27. The craft kit of claim 25 wherein the construction elements comprise an elongate strip having four separate fold lines along its length, thereby defining five panels, one panel at one end of the elongate strip and three other panels adjacent to each other having adhesive thereon, the remaining panel not having adhesive thereon.

28. The craft kit of claim 27 wherein the five panels are all substantially the same size.

29. The craft kit of claim 10 wherein the selective areas coated with adhesive are all on one surface of the sheet member.

30. The craft kit of claim 12 wherein the selective areas coated with adhesive are all on one surface of the sheet member.

31. The craft kit of claim 13 wherein the selective areas coated with adhesive are all on one surface of the sheet member.

32. The craft kit of claim 22 wherein the selective areas coated with adhesive are all on one surface of the sheet member.

33. The craft kit of claim 24 wherein the selective areas coated with adhesive are all on one surface of the sheet member.

34. The craft kit of claim 25 wherein the selective areas coated with adhesive are all on one surface of the sheet member.
